(19) United States
(12) Patent Application Publication
(10) Pub. No.: US 2026/0244667 A1
(43) Pub. Date: Aug. 20, 2026

(54) AI-POWERED NLP AND CONVERSATIONAL INTERFACES TO EXECUTE IAM

(71) Applicants: SANJAY NADIMPALLI, foster city, CA (US); BHAMIDIPATI VENKATA SUBBARAYA DURGA PRASAD, bangalore (IN)

(72) Inventors: SANJAY NADIMPALLI, foster city, CA (US); BHAMIDIPATI VENKATA SUBBARAYA DURGA PRASAD, bangalore (IN)

(21) Appl. No.: 19/373,674

(22) Filed: Oct. 29, 2025

Related U.S. Application Data
(60) Provisional application No. 63/713,267, filed on Oct. 29, 2024.

(51) Int. Cl. G06F 16/334; G06F 16/35; G06F 18/21; G06F 21/44; G06F 40/284

(52) U.S. Cl. CPC G06F 16/3344; G06F 16/35; G06F 18/217; G06F 21/44; G06F 40/284

(57) ABSTRACT

A computer-implemented method for interpreting and executing identity and access management (IAM) policies across heterogeneous systems is disclosed. The method includes receiving a policy document expressed in natural language and analyzing it, by a planning and reasoning engine, to identify entities, actions, and control relationships associated with IAM processes. The document is classified according to an IAM process template stored in an IAM process knowledge base and converted, by a user planning and orchestration agent, into a structured runbook specification defining executable parameters and enforcement actions. The user planning and orchestration agent delegates the runbook specification to a vendor process agent corresponding to a target IAM product. The vendor process agent translates the runbook into vendor-specific configuration instructions compatible with an application programming interface, and one or more task agents execute the instructions on the target IAM product to enforce the IAM process defined in the runbook.

### CLAIM OF PRIORITY

This application claims priority to U.S. Provisional Patent Application No. 63/713,267, filed on Oct. 29, 2024 and titled AI-POWERED NLP AND CONVERSATIONAL INTERFACES TO EXECUTE IAM. This provisional patent application is hereby incorporated by reference in its entirety.

### BACKGROUND

### Field of the Invention

The present disclosure relates to computer-implemented methods and architectures for managing digital identity and access control. More particularly, it relates to artificial intelligence powered natural language processing and conversational interface technologies configured to execute Identity and Access Management (IAM) policies and workflows across heterogeneous vendor environments.

### Background

Enterprises maintain increasingly distributed identity ecosystems composed of multiple directory services, access governance platforms, and privileged access management tools. Each product implements unique policy schemas, configuration languages, and integration interfaces. Maintaining a consistent security posture across these heterogeneous systems requires continuous translation of organizational policy intent into vendor-specific technical configurations.

Identity and Access Management policies are typically authored as static textual documents that define password complexity, access review schedules, and entitlement approval workflows. Implementing these policies across multiple products is usually performed through manual configuration steps by administrators or external service integrators. This manual mapping is slow, expensive, and prone to human error, often leading to incomplete or inconsistent enforcement of security requirements.

Verification and auditing present additional challenges. Administrators and auditors must log into separate consoles or run vendor-specific scripts to verify the status of user privileges, reviews, or compliance rules. The absence of a unified, language-based interface for interacting with the entire IAM landscape limits visibility and responsiveness to policy changes or audit findings.

As identity environments expand in scale and complexity, these limitations increase operational risk, elevate compliance costs, and reduce the organization's ability to enforce least-privilege and zero-trust principles effectively. There is therefore a need for a computer-implemented approach capable of interpreting policy intent expressed in natural language, converting such intent into structured, enforceable specifications, and enabling policy execution and query across multiple IAM products without manual intervention.

### SUMMARY OF THE INVENTION

A computer-implemented method for automatically interpreting and executing identity and access management (IAM) policies across heterogeneous systems is provided. The method includes receiving, by a user planning and orchestration agent executed on one or more processors, a policy document expressed in natural language. The method further includes analyzing, by a planning and reasoning engine, the policy document to identify entities, actions, and control relationships associated with IAM processes. The method also includes classifying the policy document according to an IAM process template stored in an IAM process knowledge base. The method includes converting, by the user planning and orchestration agent, the policy document into a structured runbook specification that defines executable policy parameters, entity mappings, and enforcement actions. The method further includes delegating, by the user planning and orchestration agent, the runbook specification to a vendor process agent corresponding to a target IAM product. The vendor process agent can then translate the runbook specification into vendor-specific configuration instructions that are compatible with an application programming interface of the target IAM product. Finally, the method includes executing, by one or more task agents, the configuration instructions on the target IAM product to enforce the IAM process defined in the runbook specification.

### BRIEF DESCRIPTION OF THE DRAWINGS

FIG. 1 illustrates an example AI-powered NLP and conversational interfaces to execute IAM, according to some embodiments.

FIG. 2 illustrates an example process implemented by an AI-powered natural-language interface system configured to automate both enforcement and conversational access within an Identity and Access Management (IAM) environment, according to some embodiments.

FIG. 3 illustrates an example table representing a structured runbook used for implementing organizational Identity and Access Management (IAM) policies and processes, according to some embodiments.

FIG. 4 illustrates an example screen corresponding to an Ask Flow executed within the AI-powered natural language processing and conversational interface architecture for IAM, according to some embodiments.

FIG. 5 illustrates an example table representing an asset-specific runbook designed to manage compliance and security risk across enterprise applications, according to some embodiments.

FIG. 6 illustrates a multi-agent system architecture configured to interpret, plan, and execute IAM policies and processes across heterogeneous vendor environments, according to some embodiments.

FIG. 7 illustrates an example process for implement enforcement of policies and processes as a Runbook Flow, according to some embodiments.

FIG. 8 illustrates a user planning and orchestration agent, according to some embodiments.

FIG. 9 illustrates a task agent process, according to some embodiments.

FIG. 10 illustrates an agent process, according to some embodiments.

FIG. 11 illustrates a query agent and query bots, according to some embodiments.

FIG. 12 illustrates a deployment topology, according to some embodiments.

FIG. 13 illustrates a platform, according to some embodiments.

The Figures described above are a representative set and are not representative and are not exhaustive with respect to embodying the invention.

### DESCRIPTION

Disclosed are a system, method, and article of manufacture of an AI-powered NLP and conversational interfaces to execute IAM. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to one embodiment, an embodiment, ‘one example,’ or similar language means that a particular feature, structure, or characteristic described in connection with the embodiment is included in at least one embodiment of the present invention. Thus, appearances of the phrases in one embodiment, in an embodiment, and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc. to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Artificial neural network is a mathematical model used to approximate nonlinear functions. Artificial neural networks are used to solve artificial intelligence problems. An ANN is made of connected units or nodes called artificial neurons, which loosely model the neurons in a brain. These are connected by edges, which model the synapses in a brain. An artificial neuron receives signals from connected neurons, then processes them and sends a signal to other connected neurons. The signal is a real number, and the output of each neuron is computed by some non-linear function of the sum of its inputs, called the activation function. Neurons and edges typically have a weight that adjusts as learning proceeds. The weight increases or decreases the strength of the signal at a connection. In some examples, neurons are aggregated into layers. Different layers may perform different transformations on their inputs. Signals travel from the first layer e.g. the input layer to the last layer e.g. the output layer, possibly passing through multiple intermediate layers e.g. hidden layers.

Generative pre-trained transformers GPT are a type of large language model LLM and a prominent framework for generative artificial intelligence. They are artificial neural networks that are used in natural language processing tasks. GPTs are based on the transformer architecture, pre-trained on large data sets of unlabeled text, and able to generate novel human-like content.

Identity and Access Management (IAM) can be a framework of policies, processes, and technologies configured to enable an organization to define, manage, and enforce digital identities and access rights across distributed computing environments. IAM can include mechanisms for authentication, authorization, identity governance, and access auditing. IAM systems can determine who a digital identity is, verify that identity using authentication methods (e.g., passwords, tokens, biometrics, or multi-factor authentication), and enforce access control decisions through authorization mechanisms (e.g., role-based access control (RBAC), attribute-based access control (ABAC), or policy-based access control (PBAC). IAM systems can further manage lifecycle events associated with digital identities, including creation, modification, and deactivation of user accounts, privileges, and credentials. IAM systems can also integrate with external identity providers (IdPs) and service providers (SPs) via standardized protocols such as Lightweight Directory Access Protocol (LDAP), Security Assertion Markup Language (SAML), OpenID Connect (OIDC), or OAuth 2.0. IAM can encompass multiple functional domains such as identity governance and administration (IGA), privileged access management (PAM), and single sign-on (SSO). IAM can ensure regulatory compliance, enforce least-privilege principles, and provide centralized visibility into user entitlements and access activity. In some embodiments, IAM can serve as a foundational security layer for enterprise and cloud systems. IAM implementations can be executed using both on-premises and cloud-based infrastructures and can expose programmatic interfaces (e.g., RESTful APIs, SDKs, or command-line utilities) to enable automated provisioning, audit logging, and policy enforcement through external orchestration systems.

Large language model (LLM) is a computational model notable for its ability to achieve general-purpose language generation and other natural language processing tasks such as classification. Based on language models, LLMs acquire these abilities by learning statistical relationships from vast amounts of text during a computationally intensive self-supervised and semi-supervised training process. LLMs can be used for text generation, a form of generative AI, by taking an input text and repeatedly predicting the next token or word.

Machine learning is a type of artificial intelligence AI that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Natural Language Processing (NLP) is a field of artificial intelligence that focuses on the interaction between computers and human language. NLP aims to enable machines to understand, interpret, and generate human language in a valuable way. NLP combines computational linguistics, machine learning, and deep learning techniques to process and analyze large amounts of natural language data. NLP has a wide range of applications, including machine translation, sentiment analysis, speech recognition, and chatbots. NLP technologies continue to evolve rapidly, with recent advancements in deep learning and transformer models significantly improving the accuracy and capabilities of language-based AI systems. Example NLP algorithms and techniques can include, inter alia: Tokenization Part-of-Speech (POS); Tagging Named Entity Recognition (NER); Sentiment Analysis Text Classification Word Embedding (e.g., Word2Vec, GloVe); Recurrent Neural Networks (RNNs); Long Short-Term Memory (LSTM) networks; Transformer models (e.g., BERT, GPT); Latent Dirichlet Allocation (LDA) for topic modeling; Conditional Random Fields (CRFs); Hidden Markov Models (HMMs);

Naive Bayes Classifier Support Vector Machines (SVMs) for text classification; Seq2Seq models; for machine translation; Attention mechanisms; Dependency Parsing; Coreference Resolution Text Summarization algorithms; Stemming and Lemmatization techniques; etc. These algorithms and techniques can be n combined or used as components in more complex NLP systems.

Runbook (e.g. in a computer system or network) is a compilation of routine procedures and operations that the system administrator or operator carries out. System administrators in IT departments and NOCs can use runbooks as a reference.

### Example Methods and Systems

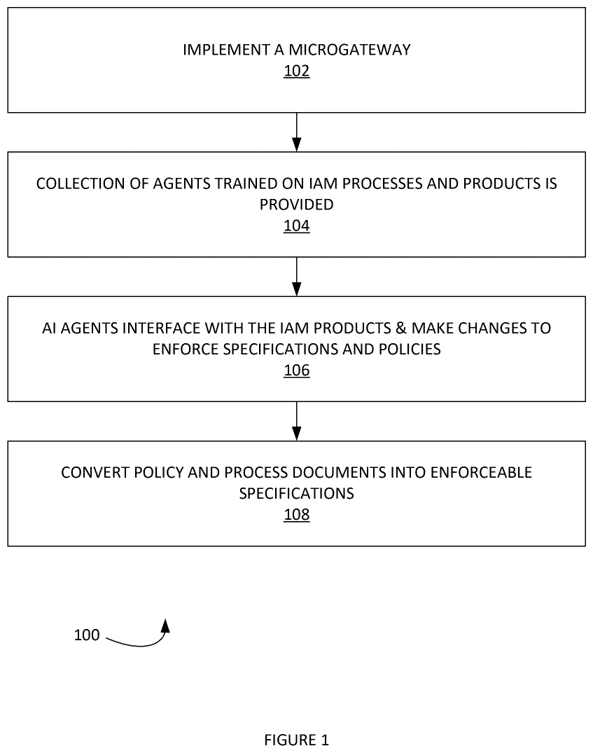

FIG. 1 illustrates an example AI-powered NLP and conversational interfaces to execute IAM, according to some embodiments. Process 100 provides an AI-driven tool designed to streamline Identity and Access Management (IAM) implementations. Process 100 can employ Natural Language Processing (NLP) and conversational interfaces to facilitate the development and execution of IAM policies and workflows based on business requirements in step 102.

Process 100 solves this problem by eliminating the manual steps.

In step 104, a collection of Agents trained on IAM processes and products is provided. The translation and enforcement are achieved through a collection of Agents trained on IAM processes and products. These AI agents can interface (e.g. “talk”) with the IAM products deployed in the customer environment and make the necessary changes to enforce the specifications and policies in step 106. In step 108, process 100 converts the policy and process documents into enforceable specifications.

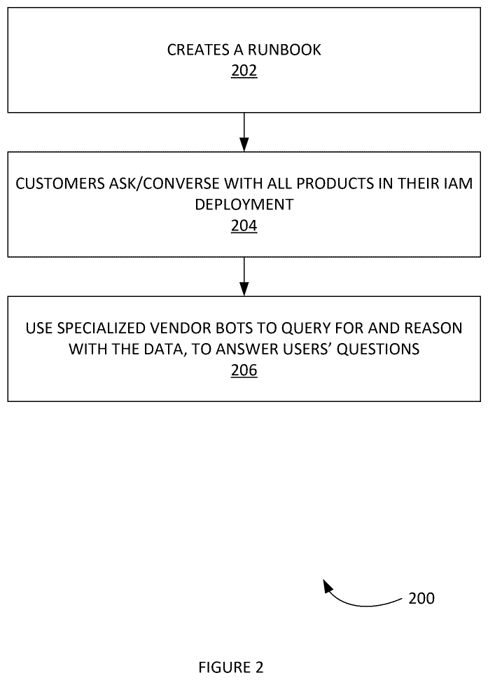

FIG. 2 illustrates an example process 200 implemented by an AI-powered natural-language interface system configured to automate both enforcement and conversational access within an Identity and Access Management (IAM) environment, according to some embodiments.

In step 202, process 200 can create a runbook based on one or more policy or process documents expressed in natural language. The system can parse the textual content of each document, identify relevant IAM entities and actions, and translate these into structured, enforceable specifications. The resulting runbook can represent an executable definition of organizational requirements such as password policies, access-review schedules, or request-approval workflows.

In step 204, process 200 can provide a conversational interface that enables customers to ask questions or issue requests across all IAM products deployed within their environment. Through this interface, users can query operational state, compliance metrics, or configuration attributes without directly interacting with individual vendor consoles. The conversational layer can employ an intent parser and a semantic mapping engine trained on IAM process ontologies to interpret the user's request and determine the appropriate system or policy context.

In step 206, process 200 can employ specialized vendor bots to query, aggregate, and reason with data retrieved from the connected IAM products. Each vendor bot can be configured with product-specific adapters that interact with the respective application programming interfaces, normalize the returned results, and provide consistent responses to the user. The reasoning component can synthesize data from multiple sources, apply policy logic from the corresponding runbooks, and return contextualized answers or actionable recommendations through the conversational interface.

Process 200 thus demonstrates how the system can unify the enforcement and query aspects of IAM operations. By automatically creating structured runbooks and enabling conversational queries through specialized agents, process 200 can reduce manual configuration effort, improve cross-product visibility, and ensure consistent application of identity and access policies across heterogeneous environments.

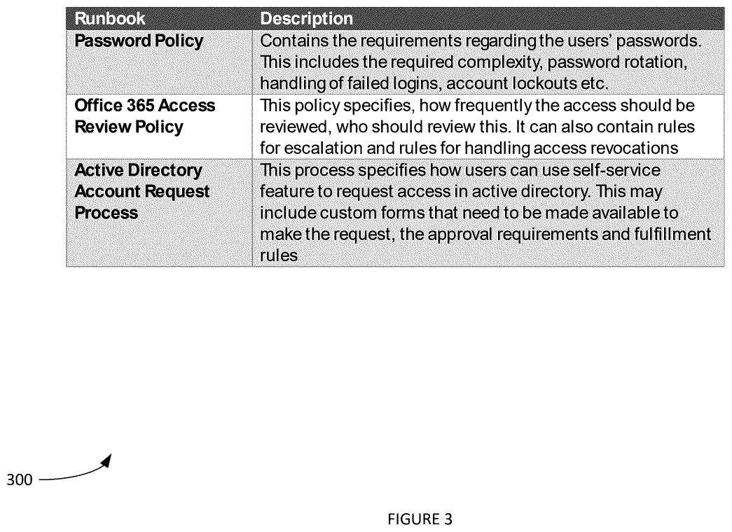

FIG. 3 illustrates an example table 300 representing a structured runbook used for implementing organizational Identity and Access Management (IAM) policies and processes, according to some embodiments. Table 300 can define enforceable specifications derived from policy or process documents authored in natural language by business or security owners. Each row of table 300 can correspond to a distinct policy component, including its description, scope, and enforcement parameters.

Table 300 can provide an intermediate representation between the unstructured natural-language source document and the machine-executable configurations produced by the AI-powered natural language processing and conversational interface architecture. When a policy document is published or uploaded, the architecture can parse the text, extract key IAM entities and actions, and populate table 300 with normalized entries describing the identified controls.

In step 202 of process 200, a runbook can be created using the contents of table 300. The runbook can serve as the authoritative specification for automating enforcement across the IAM environment. Each entry in table 300 can reference a defined control type such as password policy, access review schedule, or account request procedure, together with the relevant implementation parameters.

Table 300 can also support traceability and auditability by linking each runbook element to its originating policy statement and recording metadata such as author, creation time, and applicable system or vendor context. By structuring IAM policy intent into a standardized table form, the architecture can enable automated processing, vendor-neutral translation, and consistent enforcement of security requirements.

FIG. 3 therefore demonstrates how organizational policies expressed in natural language can be transformed into formalized, machine-readable runbooks that form the foundation for subsequent automated execution and compliance verification across heterogeneous IAM platforms.

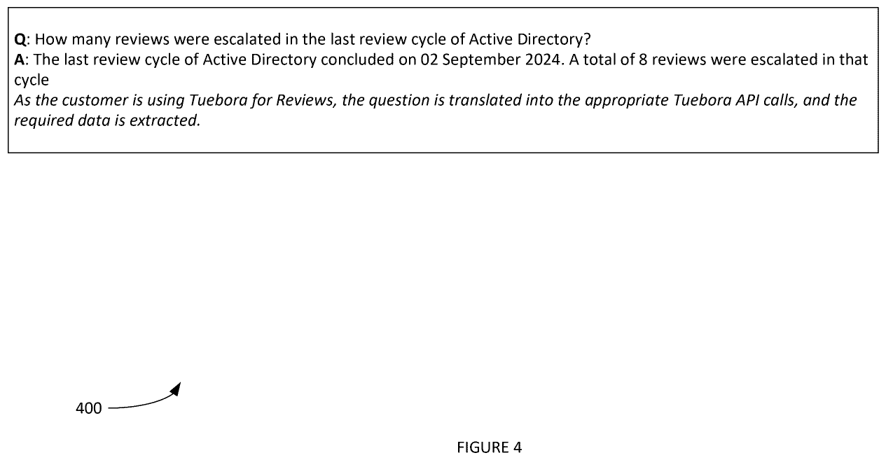

FIG. 4 illustrates an example screen 400 corresponding to an Ask Flow executed within the AI-powered natural language processing and conversational interface architecture for Identity and Access Management (IAM), according to some embodiments. The Ask Flow can provide a conversational interface that enables users to issue natural-language questions, commands, or policy verification requests spanning multiple IAM products deployed across an enterprise environment.

In step 204, a user can engage with the conversational interface to ask questions or initiate diagnostic inquiries about identity configurations, access reviews, or compliance status. The interface can accept textual or voice input and convert it into a structured intent using a natural-language understanding model trained on IAM semantics. This model can recognize entities such as users, groups, entitlements, assets, or policy types and map them to standardized representations within an IAM process ontology.

In step 206, the architecture can use specialized vendor bots to interpret the structured intent and execute queries against the connected IAM systems. Each vendor bot can include an adapter that communicates with the corresponding product through secure application programming interfaces. These adapters can normalize heterogeneous data sources into a consistent schema and apply reasoning algorithms to infer relationships, compliance outcomes, or anomalies across systems.

The conversational interface can then synthesize the collected information and return a natural-language response to the user, optionally accompanied by structured visual elements such as compliance indicators, review statistics, or configuration summaries. For example, a query such as “How many access reviews were escalated in the last cycle?” can be translated into product-specific API requests, aggregated across the relevant review platforms, and presented back with precise numerical results and contextual explanations.

Ask Flow 400 can support both on-demand queries and guided dialogue sequences. Guided dialogue can enable follow-up clarification questions, contextual drilling into results, or invocation of remediation actions where appropriate. By combining semantic understanding with vendor-specific data access, the Ask Flow can function as an intelligent query layer that spans the organization's IAM landscape.

FIG. 4 demonstrates how conversational interaction can unify information retrieval and reasoning across diverse IAM systems, according to some embodiments. Through the Ask Flow, users can obtain real-time answers about security posture and compliance health without requiring manual navigation through multiple administrative consoles or specialized scripting knowledge.

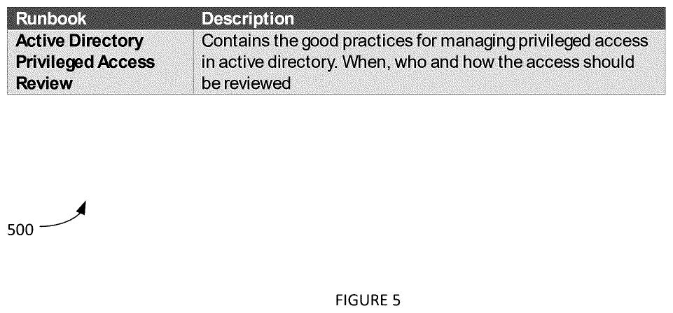

FIG. 5 illustrates an example table 500 representing an asset-specific runbook designed to manage compliance and security risk across enterprise applications, according to some embodiments. Table 500 can define a standardized template that captures configuration, review, and control requirements unique to a particular application or system. Each row of table 500 can represent a defined control objective or operational guideline derived from industry best practices and internal governance policies.

Organizations can maintain numerous applications, each with distinct risk characteristics, access models, and compliance requirements. Managing such diversity often demands detailed knowledge of product behavior, configuration options, and integration boundaries. Asset runbooks can encapsulate this knowledge into reusable templates that define how policies and controls are to be applied for each system type.

When an application is onboarded, the AI-powered natural language processing and orchestration architecture can reference the appropriate asset runbook to automatically instantiate the required access control structures, certification schedules, or entitlement reviews. The runbook can specify parameters such as frequency of access reviews, ownership of review processes, escalation logic, and remediation actions. For example, an Active Directory Privileged Access Review runbook can define who performs periodic reviews, what criteria trigger escalation, and how expired entitlements are revoked.

Table 500 can serve as both a prescriptive guide and an enforcement artifact. It can provide a baseline that defines minimum acceptable configurations and expected control behaviors for the application. Administrators or AI agents can extend or modify these templates to meet organizational needs while preserving alignment with regulatory or framework requirements such as ISO 27001, SOC 2, or NIST 800-53.

The structured representation in table 500 can also facilitate auditing and policy reconciliation. Each asset runbook can maintain traceability to the originating policy documents, vendor-specific configurations, and enforcement outcomes recorded in runbook execution logs. This structure enables consistent comparison between expected and actual security postures across multiple assets.

By defining asset runbooks in a standardized tabular form, the architecture can apply common governance logic across diverse applications while preserving the ability to customize per-asset enforcement. FIG. 5 therefore demonstrates how formalized templates can translate high-level security intent into application-specific, verifiable, and repeatable IAM control structures.

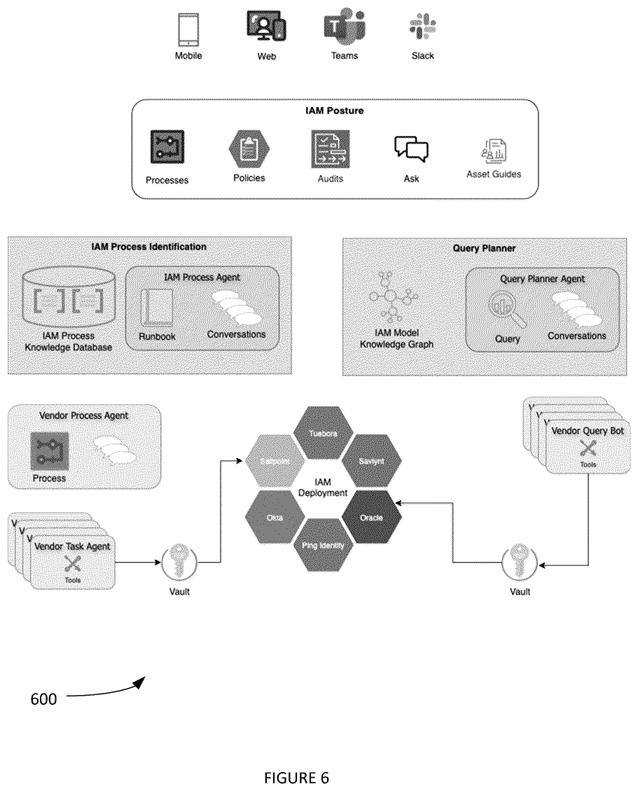

FIG. 6 illustrates a multi-agent system architecture 600 configured to interpret, plan, and execute Identity and Access Management (IAM) policies and processes across heterogeneous vendor environments, according to some embodiments. Multi-agent system architecture 600 can include a coordinated set of engines and agents that collectively transform natural-language policy intent into enforceable configurations and enable reasoning over distributed IAM data.

A user interface engine 602 can provide an interactive conversational layer through which administrators, auditors, or compliance officers define, modify, or query IAM policies. User interface engine 602 can support text, voice, or graphical interactions and can relay requests to a downstream orchestration tier for interpretation and execution.

A planning and reasoning engine 604 can receive structured representations of user input and determine the corresponding operational intent. Planning and reasoning engine 604 can reference contextual data, ontological mappings, and policy templates to decompose natural-language directives into machine-executable actions. The engine can generate a hierarchical execution plan that identifies which IAM process templates are relevant and which downstream agents are required to implement them.

An IAM process knowledge base 606 can store canonical models representing policy categories, control frameworks, and standardized IAM workflows. The knowledge base can maintain metadata describing dependencies between authentication, authorization, and governance processes. Planning and reasoning engine 604 can query IAM process knowledge base 606 to validate logical consistency and to align incoming directives with known IAM control structures.

A vendor process agent 608 can act as an intermediate translation layer between normalized policy intent and vendor-specific product implementations. Vendor process agent 608 can reference product metadata, available APIs, and permissible configuration parameters to generate an implementation plan suitable for a particular IAM system such as a directory service, access governance platform, or privileged access vault.

A task execution agent 610 can perform discrete operations defined by the vendor process agent 608. Task execution agent 610 can establish authenticated sessions with connected IAM systems, apply configuration changes, validate outcomes, and log all enforcement results. Each task execution agent can be specialized for a particular domain, such as user provisioning, entitlement updates, or access review scheduling.

An IAM product layer 612 can represent the target enforcement and data systems integrated with multi-agent system architecture 600. IAM product layer 612 can include external platforms such as Okta, SailPoint, CyberArk, or other compatible identity systems, each exposing APIs that support configuration and query operations.

An IAM metadata knowledge graph 614 can represent a semantic data model capturing entities, attributes, and relationships across multiple IAM systems. IAM metadata knowledge graph 614 can include nodes for users, accounts, assets, privileges, reviews, violations, and controls, and edges representing logical or operational relationships among them. The knowledge graph can enable reasoning across system boundaries, allowing correlated insight into policy compliance and user activity.

A query bot layer 616 can comprise a set of specialized agents configured to retrieve and aggregate information from IAM product layer 612. Each query bot can interpret structured queries produced by planning and reasoning engine 604, access product-specific APIs, and normalize returned data for further synthesis. Query bot layer 616 can also support inferential reasoning using metadata relationships from knowledge graph 614 to provide contextualized answers.

During enforcement, user interface engine 602 transmits user directives to planning and reasoning engine 604, which consults IAM process knowledge base 606 to produce a normalized plan. Vendor process agent 608 then translates the plan into executable instructions for task execution agent 610, which interacts with IAM product layer 612 to perform the desired operations. During query cycles, the process is reversed: query bot layer 616 collects data from IAM product layer 612, references IAM metadata knowledge graph 614 for context, and returns synthesized results to planning and reasoning engine 604 for presentation through user interface engine 602.

Multi-agent system architecture 600 therefore establishes an extensible, intelligent orchestration framework capable of interpreting natural-language IAM policy intent, coordinating enforcement across heterogeneous vendor systems, and providing unified reasoning and visibility across distributed identity infrastructures.

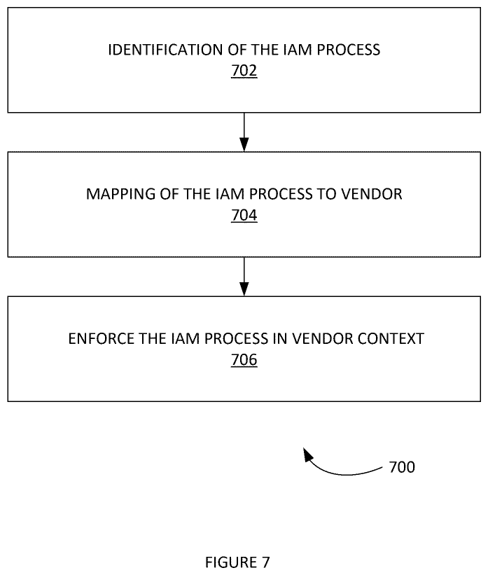

FIG. 7 illustrates an example process 700 for implementing enforcement of policies and processes as a Runbook Flow, according to some embodiments. In step 702, process 700 performs identification of the IAM process. In step 704, process 700 implements mapping of the IAM process to Vendor. In step 706, process 700 implements enforcing the IAM process in vendor context.

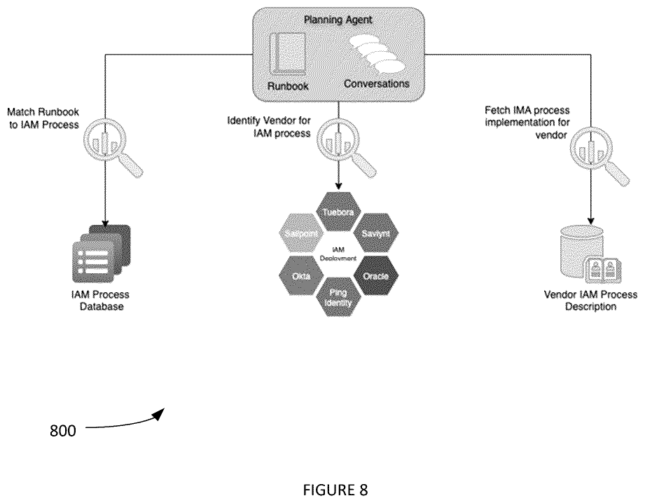

FIG. 8 illustrates a user planning and orchestration agent 800, according to some embodiments. User planning and orchestration agent 800 can implement process 700 and can operate as the central coordination layer within multi-agent system architecture 600. User planning and orchestration agent 800 can include, inter alia, a vendor process agent 802, a plurality of task agents 804, 806, and 808, and one or more target systems 810. A user can interact with user planning and orchestration agent 800 through a user interface engine 602 to initiate execution of an identity and access management (IAM) process.

User planning and orchestration agent 800 can perform IAM process identification by analyzing input received from the planning and reasoning engine 604 and consulting the IAM process knowledge base 606. The agent can classify the user's request, identify the applicable IAM process, and retrieve the corresponding runbook template. Once identified, the agent can associate the request with a runbook specification that defines the context, participating entities, and required actions.

After classification, user planning and orchestration agent 800 can delegate execution to vendor process agent 802. Vendor process agent 802 can analyze the runbook specification and translate it into a vendor-specific implementation plan compatible with a particular IAM product. Vendor process agent 802 can then decompose the plan into discrete actions and assign each action to a corresponding task agent 804, 806, or 808.

Each task agent can interact directly with target system 810 to perform its assigned operation, such as creating a form, applying a password policy, updating access rules, or scheduling an access review. Task agents can also validate results, collect execution feedback, and report completion status to vendor process agent 802. Vendor process agent 802 can aggregate task-level outcomes and communicate an overall execution summary back to user planning and orchestration agent 800. The orchestration agent can verify the results against expected runbook parameters and return a completion report to the user through user interface engine 602.

In some embodiments, IAM process identification can be implemented within user planning and orchestration agent 800. The agent can use IAM process knowledge base 606 to extract the IAM process associated with a submitted document or command. This identification step can attach a contextual and semantic layer to the input, establishing the linkage between natural-language content and enforceable IAM constructs. The process can enable automatic conversion of the document or command into a structured runbook.

The IAM process identification step can also attach a knowledge dictionary to the document or policy input. For example, when a document describing an organization's password policy is submitted, user planning and orchestration agent 800 can analyze its contents and identify the relevant IAM process. The resulting context can include entities such as users, passwords, password complexity, single sign-on, multi-factor authentication, and account lockouts, as well as actions such as user registration, password reset, or account expiration.

Once the IAM process has been identified, user planning and orchestration agent 800 can determine which vendor manages that process within the deployment and delegate enforcement to vendor process agent 802. Vendor process agent 802 can be trained on the configuration schema, access model, and API conventions of the target IAM product. Vendor process agent 802 can parse the runbook, construct a stepwise enforcement plan, and coordinate the sequence of operations needed to apply the corresponding configuration. Vendor process agent 802 can rely on one or more task agents to implement the atomic actions defined in the plan.

Vendor process agent 802 can first prepare the plan for enforcing the runbook, identifying the required modifications to target system 810. Upon generating the plan, vendor process agent 802 can obtain user consent for the proposed changes before applying them. After approval, vendor process agent 802 can direct task agents 804, 806, and 808 to execute the specific operations on the target system. The agent can monitor each operation, confirm successful application, and log results for audit and rollback purposes.

Task agents can abstract IAM tasks on vendor products, providing an atomic operational layer that isolates vendor-specific complexity from higher-level orchestration. Each task agent can interpret a single requirement, translate it into a concrete specification, and execute it through the appropriate product interface. For example, a custom forms task agent can generate and apply form specifications within a product environment such as Tuebora, while another task agent can enforce password complexity rules within a directory service. This modular delegation model allows concurrent task execution, fine-grained auditability, and scalable automation across heterogeneous IAM systems.

FIG. 8 therefore illustrates user planning and orchestration agent 800, according to some embodiments, as the intermediary coordination tier that links high-level IAM policy interpretation with low-level vendor-specific execution, enabling distributed automation, traceability, and consistent enforcement across complex enterprise identity environments.

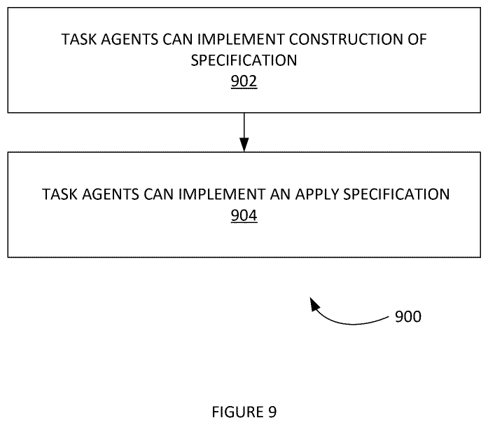

FIG. 9 illustrates a task agent process 900, according to some embodiments. Task agent process 900 can represent the operational flow executed by individual task agents, such as task agents 804, 806, and 808 within user planning and orchestration agent 800. Task agent process 900 can define two principal phases of operation: construction of specification and application of specification. These phases can enable the conversion of abstract IAM requirements into actionable, product-specific implementations.

In step 902, task agent process 900 can perform construction of specification. During this phase, a task agent can receive a discrete requirement from vendor process agent 802, such as a directive to create a form, define a password complexity rule, or initiate an access review cycle. The task agent can parse the directive, reference relevant schemas, and construct a detailed specification representing the exact configuration changes to be performed within target system 810. This construction step can be iterative and may involve clarification requests or parameter validation to ensure the resulting specification aligns precisely with the runbook intent.

The specification can be generated in the native configuration syntax or object model of the target product, enabling direct consumption by that system's application programming interfaces. For example, if the target system is an identity governance platform, the task agent can create a JSON or XML payload representing the required workflow definition, approval hierarchy, or review rule set. Once completed, the specification can be stored in an intermediate buffer pending user or orchestration-level confirmation.

In step 904, task agent process 900 can perform application of specification. In this phase, the task agent can execute the prepared specification against target system 810, establishing a secure and authenticated session through the appropriate product connector. The task agent can then submit the specification to the corresponding API endpoints or administrative interfaces, monitor execution responses, and validate the results. Validation can include querying the target system to confirm that the configuration state matches the expected outcome recorded in the runbook.

Task agent process 900 can include exception handling and rollback logic to preserve system integrity. If an execution error or inconsistency is detected, the task agent can revert to the prior configuration state using pre-captured metadata from the construction phase. The agent can also generate structured telemetry and log entries that document the applied changes, execution timestamps, and validation outcomes. These records can be transmitted back to vendor process agent 802 for aggregation and audit reporting.

Task agent process 900 can therefore provide a controlled and auditable mechanism for translating discrete IAM requirements into verified, vendor-specific configuration updates. By encapsulating the construction and application logic within dedicated task agents, multi-agent system architecture 600 can achieve modular scalability, consistent enforcement, and traceable execution across diverse IAM environments.

FIG. 9 illustrates task agent process 900, according to some embodiments, as the atomic execution layer that enables precise, verifiable, and reversible enforcement of IAM configurations under orchestration of higher-level agents.

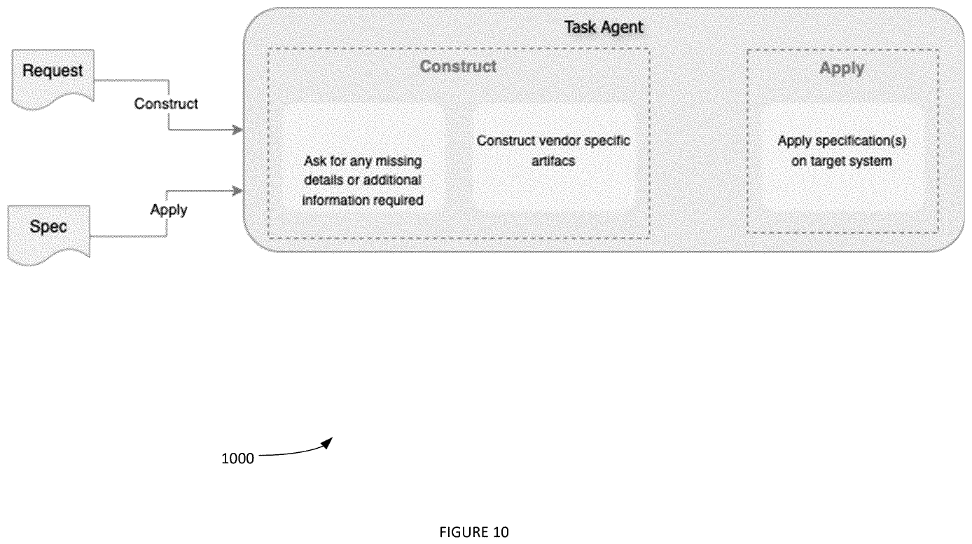

FIG. 10 illustrates an agent process 1000, according to some embodiments. Agent process 1000 can represent the operational flow executed by a class of autonomous agents within multi-agent system architecture 600, including but not limited to user planning and orchestration agent 800, vendor process agent 802, and task agents 804, 806, and 808. Agent process 1000 can govern how these agents interpret, plan, and respond to user requests, enabling adaptive orchestration across heterogeneous IAM systems.

Agent process 1000 can begin with the reception of an instruction or query, which may originate from a user through the user interface engine 602 or from another upstream agent. Upon receiving the input, the agent can parse the instruction to identify its type, scope, and intent. For example, a directive may specify an enforcement operation, a data retrieval request, or a policy validation check. The agent can use embedded natural-language understanding models, rule-based classifiers, or ontological mappings from IAM process knowledge base 606 to extract the relevant parameters.

After classification, the agent can generate an internal representation of the request, identifying dependent entities and required subtasks. If the agent functions as a planning component, it can construct a hierarchical plan or decision tree that sequences these subtasks according to logical dependencies. If the agent serves as an execution component, it can allocate each subtask to the corresponding atomic operation, such as API invocation, configuration update, or data query.

During processing, the agent can establish authenticated communication with external IAM products via secure connectors. It can perform the necessary operations, monitor system responses, and adjust behavior dynamically based on observed outcomes or policy constraints. For instance, if a provisioning task fails due to conflicting entitlement rules, the agent can invoke a predefined remediation path or escalate the issue to a higher-tier reasoning agent.

Agent process 1000 can maintain stateful awareness throughout execution, recording progress, decisions, and validation results. This enables consistent error recovery, auditability, and cross-agent synchronization. Upon completion of its assigned workflow, the agent can summarize execution results and transmit a structured report to its upstream controller, such as vendor process agent 802 or user planning and orchestration agent 800. The report can include success indicators, exceptions encountered, and contextual data retrieved from target systems.

In some embodiments, agent process 1000 can also support asynchronous collaboration among multiple agents. An initiating agent can delegate certain operations to peer agents while continuing to monitor their progress through event-driven callbacks. This design enables parallel execution, improves response time, and ensures scalability across large enterprise IAM environments.

Agent process 1000 can therefore define the behavioral template for autonomous components operating within multi-agent system architecture 600. By combining structured intent parsing, adaptive decision logic, and closed-loop feedback, agent process 1000 allows each agent to operate independently while maintaining coherence with the overall orchestration framework.

FIG. 10 illustrates agent process 1000, according to some embodiments, as the unified operational model for agents performing planning, reasoning, or execution roles within the distributed IAM automation ecosystem.

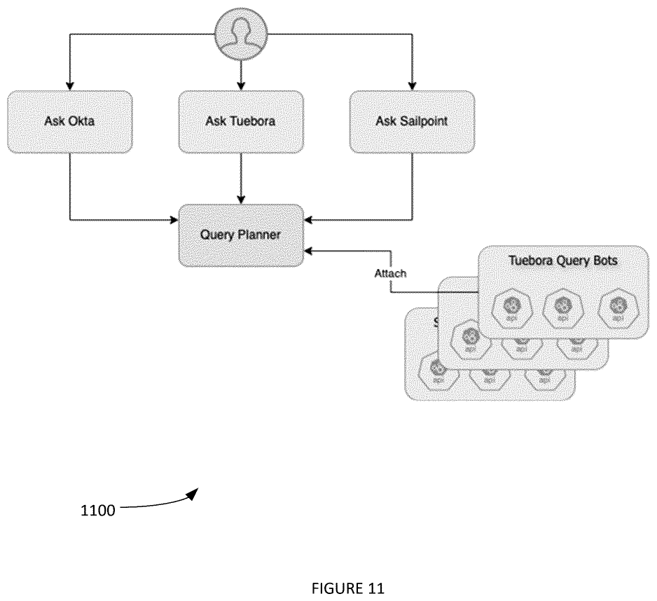

FIG. 11 illustrates a query agent and query bots 1100, according to some embodiments. Query agent and query bots 1100 can implement an intelligent data retrieval and reasoning framework within multi-agent system architecture 600, enabling natural-language query execution, contextual interpretation, and cross-system data aggregation across connected IAM products. Query agent and query bots 1100 can transform user questions or audit requests into structured, vendor-specific queries and synthesize responses using semantic knowledge contained within IAM metadata knowledge graph 614.

A query planner agent can receive a query expressed in natural language from user interface engine 602 or from an upstream orchestration component such as user planning and orchestration agent 800. Upon receiving the query, the query planner agent can parse the request to identify entities, relationships, and intent. The agent can reference IAM process knowledge base 606 and IAM metadata knowledge graph 614 to construct a semantic representation of the query, defining the objects, attributes, and relationships necessary to generate an accurate response.

Once the query is represented semantically, the query planner agent can decompose it into a set of sub-queries, each directed to a particular vendor system or data domain. For example, a single high-level question such as “Which users have privileged access to inactive applications?” can be decomposed into sub-queries targeting a directory service for user status, an access governance platform for entitlement data, and a privileged access management vault for account roles. Each sub-query can be dispatched to a corresponding vendor query bot trained on the specific data models and APIs of that product.

Each vendor query bot can execute its assigned sub-query through authenticated connections to the respective IAM product layer 612. Vendor query bots can retrieve relevant data, normalize the output into a common schema, and return results to the query planner agent. During this process, metadata enrichment can occur through IAM metadata knowledge graph 614, which can resolve cross-system identifiers, infer relationships between entities, and detect policy violations or inconsistencies.

The query planner agent can then aggregate the normalized data from multiple vendor query bots and apply reasoning logic to synthesize a unified result set. This reasoning can include correlation of user identities across systems, mapping of entitlements to applications, computation of compliance metrics, or generation of natural-language explanations. The final synthesized response can be transmitted to user interface engine 602, allowing the initiating user to receive an intelligible answer in conversational form along with any structured summaries or visual indicators.

In some embodiments, query agent and query bots 1100 can maintain a library of reusable query templates aligned with common compliance and audit tasks. These templates can accelerate routine investigations such as access certification reviews, segregation-of-duties checks, or anomaly detection. The system can also support adaptive learning, enabling query bots to refine their mappings and normalization rules based on historical results.

Query agent and query bots 1100 can therefore provide the analytical and interpretive foundation for real-time interrogation of distributed IAM systems. By combining semantic decomposition, multi-source data retrieval, and reasoning over a unified knowledge graph, query agent and query bots 1100 enable accurate, context-aware responses to natural-language questions about enterprise identity posture.

FIG. 11 illustrates query agent and query bots 1100, according to some embodiments, as the semantic query and aggregation layer that bridges natural-language understanding with federated IAM data intelligence.

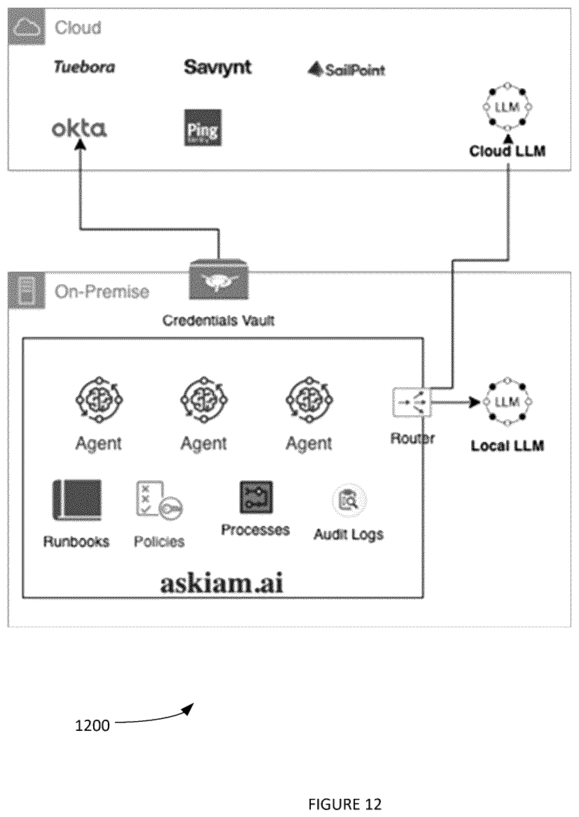

FIG. 12 illustrates a deployment topology 1200, according to some embodiments. Deployment topology 1200 can represent the physical and logical arrangement of the components of multi-agent system architecture 600 across computing environments. Deployment topology 1200 can support flexible configurations, including fully on-premises, hybrid cloud, or hosted deployments, depending on organizational security and compliance requirements.

Deployment topology 1200 can include multiple operational zones interconnected through secure communication channels. An orchestration zone can host user interface engine 602, planning and reasoning engine 604, user planning and orchestration agent 800, and vendor process agent 802. This orchestration zone can reside within an organization's controlled network perimeter and can communicate with both upstream user endpoints and downstream IAM product environments through authenticated connectors.

A data and knowledge management zone can include IAM process knowledge base 606 and IAM metadata knowledge graph 614. This zone can be responsible for semantic storage, ontology management, and policy mapping. The data and knowledge management zone can be isolated from direct external access, with communications limited to encrypted requests from authorized agents within orchestration zone.

A connector and integration zone can include task execution agents 804, 806, and 808, query bot layer 616, and API gateway modules configured to interact with external IAM product layer 612. This zone can facilitate bi-directional communication between internal orchestration components and vendor-specific systems. Each connection can be established using secure transport protocols, token-based authentication, and ephemeral session credentials obtained from a centralized credential vault.

Deployment topology 1200 can also incorporate a vault subsystem responsible for managing all credentials used by the multi-agent architecture. The vault can securely store access keys, API tokens, and encryption secrets needed to authenticate with target systems. Task agents and query bots can retrieve credentials on-demand from the vault using short-lived tokens, ensuring that no sensitive material is persistently stored within orchestration memory.

Data persistence within deployment topology 1200 can follow a principle of non-retention. During enforcement flows, runbook specifications can be transmitted to target systems for application but not permanently stored within orchestration infrastructure. During query flows, retrieved data can be processed in memory, aggregated, and synthesized into user-facing responses without being retained beyond the active session. Only metadata such as audit logs, configuration fingerprints, and system health metrics can be stored persistently for compliance and diagnostics.

In some embodiments, deployment topology 1200 can implement network segmentation to separate orchestration control traffic from data retrieval channels. Control messages exchanged between engines and agents can traverse an internal message bus or asynchronous queue, while data plane traffic used by task agents and query bots can pass through an API gateway layer that enforces fine-grained access policies.

Deployment topology 1200 can therefore enable secure, modular, and compliant operation of multi-agent system architecture 600. By separating orchestration logic, knowledge management, and external integrations into distinct zones, deployment topology 1200 provides high isolation, strong credential governance, and minimal data exposure across IAM enforcement and query workflows.

FIG. 12 illustrates deployment topology 1200, according to some embodiments, as a layered and security-hardened environment that supports scalable, policy-compliant execution of IAM automation and reasoning functions across enterprise infrastructure.

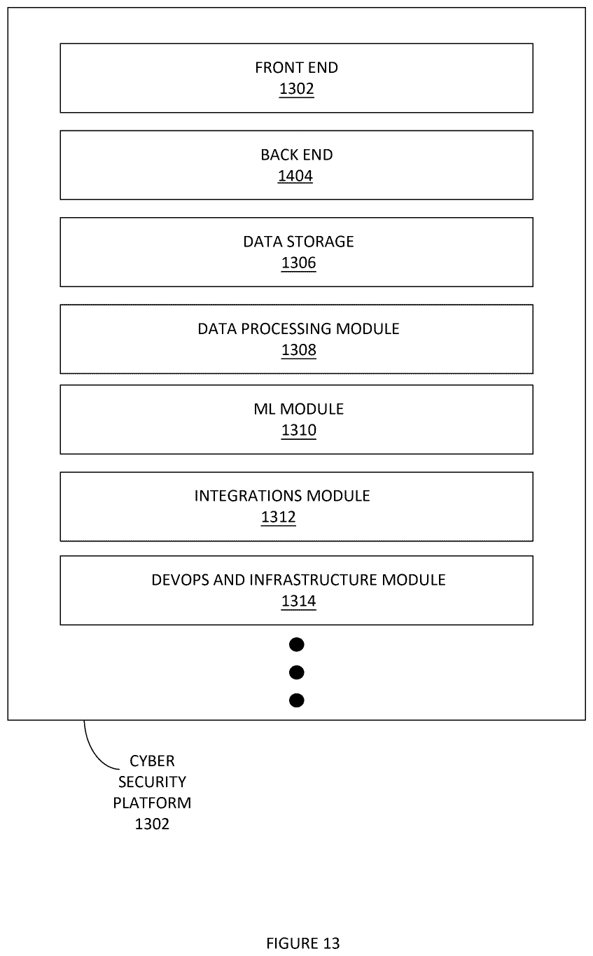

FIG. 13 illustrates a platform 1300, according to some embodiments. Platform 1300 can provide the foundational computing infrastructure and application framework supporting multi-agent system architecture 600. Platform 1300 can enable orchestration, data processing, visualization, and machine learning operations that collectively deliver policy automation and reasoning capabilities across identity and access management environments.

Platform 1300 can include a frontend layer 1302 that manages user interaction and visualization. Frontend layer 1302 can implement a web-based or desktop interface configured to render the conversational environment, workflow designer, and reporting dashboards. Frontend layer 1302 can incorporate a data visualization library for rendering interactive charts, graphs, and compliance indicators, and a state management framework for synchronizing user sessions across multiple views. A workflow designer can allow administrators to construct custom runbook templates using a drag-and-drop interface that connects policy components, triggers, and vendor actions. Frontend layer 1302 can also include a UI component library that ensures visual consistency and accessibility across devices.

A backend layer 1304 can manage application logic, request routing, and coordination among microservices. Backend layer 1304 can include an API gateway that authenticates incoming requests, enforces access policies, and directs traffic to appropriate microservices. These microservices can include, among others, user management, workflow management, threat intelligence, user risk analysis, configuration management, and reporting services. Backend layer 1304 can also include an asynchronous message queue for task orchestration, a workflow execution engine for running automated processes, and a caching layer to accelerate frequently accessed data.

A data storage layer 1306 can manage structured, semi-structured, and unstructured data persistence. Data storage layer 1306 can include a relational database for user accounts, configuration data, and workflow definitions; a document database for unstructured records such as audit reports and knowledge base entries; and a time-series database for capturing system telemetry, execution metrics, and trend analysis. The data storage layer can be deployed with encryption-at-rest and access-controlled partitions to ensure compliance with data protection standards.

A data processing layer 1308 can implement pipelines for data extraction, transformation, and loading from heterogeneous sources. Data processing layer 1308 can include a stream processing subsystem for real-time data ingestion and correlation, as well as batch processing pipelines for periodic analytics or training dataset generation. These pipelines can support distributed execution across multiple nodes for scalability.

A machine learning module 1310 can implement analytical and predictive components that enhance orchestration intelligence. Machine learning module 1310 can manage a machine learning pipeline for training, validation, and deployment of predictive models. These models can be used for user risk scoring, anomaly detection, policy recommendation, and query understanding. Machine learning module 1310 can also support integration with large language models for semantic interpretation of user input and documentation, enabling the planning and reasoning engine 604 to map natural-language directives to IAM processes with greater precision. The module can manage model serving infrastructure for real-time inference and can utilize GPU or TPU acceleration for computational efficiency.

An integrations module 1312 can manage third-party connectors, APIs, and webhook interfaces for connecting with external systems such as ticketing tools, security information and event management (SIEM) systems, or regulatory reporting dashboards. Integrations module 1312 can expose standardized interfaces that allow secure bi-directional communication, ensuring that IAM automation remains aligned with broader enterprise governance frameworks.

A DevOps and infrastructure management module 1314 can provide containerization, orchestration, monitoring, and continuous deployment capabilities. DevOps and infrastructure management module 1314 can utilize container technologies for packaging and isolating application services, and orchestration platforms such as Kubernetes for dynamic resource allocation and service scaling. Continuous integration and deployment pipelines can automate build, test, and release processes. Monitoring components can collect health metrics and generate alerts for performance anomalies, while centralized logging infrastructure can aggregate and analyze system events to support troubleshooting and compliance reporting.

Platform 1300 can therefore provide the underlying computing framework for implementing, scaling, and maintaining the components of multi-agent system architecture 600. By integrating frontend, backend, data, machine learning, and infrastructure services into a cohesive platform, platform 1300 enables reliable execution, seamless interoperability, and continuous improvement of IAM automation processes.

FIG. 13 illustrates platform 1300, according to some embodiments, as a modular and extensible foundation that unifies user interaction, orchestration intelligence, and secure data management within an enterprise-grade IAM automation ecosystem Machine Learning module 1310 can implement a ML Pipeline. This can also be used for orchestrating machine learning workflows. Model Serving can be performed for deploying and managing machine learning models (e.g., for risk scoring, etc.). Machine learning is a type of artificial intelligence AI that provides computers with the ability to learn without being explicitly programmed. Machine learning focuses on the development of computer programs that can teach themselves to grow and change when exposed to new data. Example machine learning techniques that can be used herein include, inter alia: Artificial Intelligence Models, Large Language Models, Generative Neural Networks, Physics Informed Neural Networks, Artificial General Intelligence Models, decision tree learning, association rule learning, artificial neural networks, inductive logic programming, support vector machines, clustering, Bayesian networks, reinforcement learning, representation learning, similarity, and metric learning, and/or sparse dictionary learning. Random forests RF e.g. random decision forests are an ensemble learning method for classification, regression, and other tasks, which operate by constructing a multitude of decision trees at training time and outputting the class that is the mode of the classes e.g. classification or mean prediction e.g. regression of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters e.g. weights of connections between neurons in artificial neural networks of the model. The model e.g. a neural net or a naive Bayes classifier is trained on the training dataset using a supervised learning method e.g. gradient descent or stochastic gradient descent. In practice, the training dataset often consist of pairs of an input vector or scalar and the corresponding output vector or scalar, which is commonly denoted as the target or label. The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters e.g. the number of hidden units in a neural network. Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training e.g. in cross-validation, the test dataset is also called a holdout dataset. It is noted that multiple APIs can be utilized. These can include, by way of example, a ChatGPT API to generate content. Also user can choose different LLMs like Llama, Claude, ChatGPT etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software e.g. embodied in a machine-readable medium.

In addition, it can be appreciated that the various operations, processes, and methods disclosed herein can be embodied in a machine-readable medium and/or a machine accessible medium compatible with a data processing system e.g. a computer system and can be performed in any order e.g. including using means for achieving the various operations. Accordingly, the specification and drawings are to be regarded in an illustrative rather than a restrictive sense. In some embodiments, the machine-readable medium can be a non-transitory form of machine-readable medium.

What is claimed by United States Patent:

1. A computer-implemented method for automatically interpreting and executing identity and access management (IAM) policies across heterogeneous systems, the method comprising:
receiving, by a user planning and orchestration agent executed on one or more processors, a policy document expressed in natural language;
analyzing, by a planning and reasoning engine, the policy document to identify entities, actions, and control relationships associated with IAM processes;
classifying the policy document according to an IAM process template stored in an IAM process knowledge base;
converting, by the user planning and orchestration agent, the policy document into a structured runbook specification defining executable policy parameters, entity mappings, and enforcement actions;
delegating, by the user planning and orchestration agent, the runbook specification to a vendor process agent corresponding to a target IAM product;
translating, by the vendor process agent, the runbook specification into vendor-specific configuration instructions compatible with an application programming interface of the target IAM product; and
executing, by one or more task agents, the configuration instructions on the target IAM product to enforce the IAM process defined in the runbook specification.

2. The method of claim 1, wherein analyzing the policy document further comprises performing tokenization, semantic classification, and ontology matching using a natural-language processing model trained on IAM domain data.

3. The method of claim 2, wherein converting the policy document into the structured runbook specification further comprises generating an IAM process identification context that links each extracted entity and action to a standardized control dictionary maintained in the IAM process

4. The method of claim 3, further comprising validating, by the user planning and orchestration agent, the execution results returned from the one or more task agents against expected parameters recorded in the runbook specification and generating an audit record describing enforcement outcomes.

5. The method of claim 4, further comprising:
in response to a query expressed in natural language, parsing the query using a query planner agent, decomposing the query into vendor-specific sub-queries, retrieving results through a plurality of query bots connected to respective IAM products, aggregating the results through an IAM metadata knowledge graph, and returning a synthesized response to a user interface engine.

6. The method of claim 5, wherein translating the runbook specification into vendor-specific configuration instructions comprises identifying available configuration schemas, parameter types, and permissible actions for the corresponding IAM product, and automatically mapping normalized fields to product-specific syntax.

7. The method of claim 6, further comprising:
obtaining, by the one or more task agents, temporary authentication credentials from a credential vault prior to executing the configuration instructions, and purging the credentials upon completion of the execution.

8. The method of claim 7, wherein the user planning and orchestration agent, the vendor process agent, and the one or more task agents communicate through a message queue operating within an orchestration zone that is network-segmented from a connector zone interfacing with the IAM products.

9. The method of claim 8, wherein the runbook specification and execution results are maintained in a non-retentive memory during enforcement and query operations, with only metadata logs and configuration fingerprints persisted for compliance auditing.

10. The method of claim 9, further comprising:
dynamically updating, by the planning and reasoning engine, mappings between natural-language policy expressions and IAM process templates based on feedback from previous executions, thereby improving accuracy of subsequent policy-to-runbook conversions.
